(19) United States
(12) Patent Application Publication
(10) Pub. No.: US 2011/0305148 A1
(43) Pub. Date: Dec. 15, 2011

(54) OPPORTUNISTIC CONCURRENT TRANSMISSION METHOD OF WIRELESS NETWORK AND WIRELESS NETWORK SYSTEM USING THE SAME

(75) Inventors: Chong Kwon Kim, Seoul (KR); Young Myoung Kang, Seoul (KR); Joon Soo Lee, Yongin (KR)

(73) Assignee: SNU R&DB FOUNDATION, Seoul (KR)

(21) Appl. No.: 12/939,928

(22) Filed: Nov. 4, 2010

(30) Foreign Application Priority Data
Jun. 14, 2010 (KR) 10-2010-0056170
Oct. 7, 2010 (KR) 10-2010-0097583

(51) Int. Cl. H04L 12/26

(52) U.S. Cl. 370/252

(57) ABSTRACT

Provided is an opportunistic concurrent transmission method for achieving efficient transmission with limited wireless resources in a WLAN environment. According to an exemplary embodiment of the present invention, when a packet to be transmitted is provided in an access point in a wireless network system, information on a link which is performing transmission from another access point is acquired by overhearing transmission from another access point, a signal to interference plus noise ratio (SINR) value of the link is verified by referring an interference map, and the packet is concurrently transmitted when the verified SINR value is equal to or more than a predetermined capture threshold.

### CROSS-REFERENCE TO RELATED APPLICATIONS

This application claims priority under 35 U.S.C. §119 to Korean Patent Application No. 10-2010-0056170, filed on Jun. 14, 2010, and No. 10-2010-0097583, filed on Oct. 7, 2010 in the Korean Intellectual Property Office, the disclosure of which is incorporated herein by reference in its entirety.

### TECHNICAL FIELD

The present invention relates to an opportunistic concurrent transmission method of a wireless network and a wireless network system using the same, and more particularly, to an opportunistic concurrent transmission method of a wireless network and a wireless network system using the same that can fully utilize the wireless capacity in terms of spatial reuse and maximize the system throughput.

### BACKGROUND

Recent proliferation of IEEE 802.11 WLANs (Wireless local area networks) stems from its attractive features such as low chipset cost, ease of deployment, and sufficient bandwidth. As IEEE 802.11 WLANs becomes a dominant wireless access technology, it requires more efficient use of scarce wireless resources.

Distributed Coordination Function (DCF), the most popular MAC protocol for IEEE 802.11 WLANs, is very simple and its distributed operations show good performance in most environment. DCF which is based on CSMA/CA (Carrier Sense Multiple Access/Collision Avoidance) prohibits concurrent transmissions in order to avoid packet collisions and harmful interferences.

However, this basic collision protection scheme (CSMA/CA) may not fully utilize the wireless resources in terms of spatial reuse due to its conservative medium access control. If we adjust the transmission order and relative signal strength, we can successfully transmit multiple packets without the collision and channel error. We call this Capture Effect.

Previous wireless NICs (Network Interface Card) enables the PHY capture when an intended signal arrives until the middle of the preamble time of an interference signal. Of course, the SINR (Signal to Interference plus Noise Ratio) value of the intended signal must satisfy the required capture threshold. Recent MIM (Message in Message)-capable NICs such as Athelos increases the PHY capture probability by using enhanced preamble detection functionality. MIM-capable NICs can capture the intended signal with higher SINR (10 dB) even if the intended signal arrives after the preamble time of an interference signal.

This is shown in FIG. 1. FIG. 1A shows PHY capture, and FIG. 1B shows MIM, respectively.

As shown in FIG. 1A, when an intended signal having high SINR of approximately 10 dB arrives within the preamble time of an interference signal, the intended signal can be captured.

With MIM function, an intended signal can be captured even though it arrives after the preamble time of an interference signal, as shown in FIG. 1B.

U.S. Pat. No. 5,987,033 is the related art for maximizing the PHY capture using MIM function. In U.S. Pat. No. 5,987,033, there are disclosed a receiver and a method for operating the receiver, for a station in a wireless local area network using a common wireless communication channel and employing a CSMA/CA protocol includes various modes. In normal mode, the receiver follows typical states in order to detect a message and demodulate data from the message properly. Meanwhile, a process implements a message-in-message (MIM) mode when an energy increase above a specified level is detected. While in the MIM mode, if a carrier is detected, the energy increase is caused by a new message; otherwise, the energy increase is caused by an interfering station. If the carrier is detected, the receiver begins retraining so that it can start receiving the new message as soon as the first message ends.

### SUMMARY

An exemplary embodiment of the present invention provides a method for transmitting a packet of an access point provided in a wireless network system that comprises: acquiring information on a link which is performing transmission from another access point by overhearing the transmission from another access point when there is a packet to be transmitted; verifying a signal to interference plus noise ratio (SINR) value of the link by referring an interference map; and concurrently transmitting the packet when the verified SINR value is equal to or more than a predetermined capture threshold.

The wireless network system may further include a central controller, and the interference map may be provided by the central controller.

The method may further comprise: entering a back off state when the verified SINR value does not reach the predetermined capture threshold; and transmitting the packet when the transmission from another access point is completed.

The access point may maintain two or more per-station queue storing packets to be transmitted to two or more client devices associated with the access point method, and the concurrently transmitting comprises scheduling to concurrently transmit a packet available for concurrent transmission among the packets stored in the per-station queues.

Another exemplary embodiment of the present invention provides a wireless network system including two or more access points, in which: when any one of the access points intends to transmit a packet, information on a link which is performing transmission is acquired from another access point by overhearing the transmission from another access point; a signal to interference plus noise ratio (SINR) value of the link is verified by referring to an interference map; and when the verified SINR value is equal to or more than a predetermined capture threshold, the packet is concurrently transmitted.

Yet another exemplary embodiment of the present invention provides an access point in a wireless network system, in which: information on a link which is performing transmission from another access point is acquired by overhearing transmission from another access point when a packet to be transmitted is provided; a signal to interference plus noise ratio (SINR) value of the link is verified by referring an interference map; and the packet is concurrently transmitted when the verified SINR value is equal to or more than a predetermined capture threshold.

Other features and aspects will be apparent from the following detailed description, the drawings, and the claims.

### BRIEF DESCRIPTION OF THE DRAWINGS

FIGS. 1A and 1B are diagrams showing transmission schedules of PHY capture and MIM capture, respectively;

FIG. 2 is a diagram showing an operation of a WLAN system according to an exemplary embodiment of the present invention;

FIG. 3 is a flowchart showing an opportunistic concurrent transmission method from a viewpoint of one AP according to an exemplary embodiment of the present invention;

FIGS. 4A and 4B are diagrams showing frame schedules in a case of concurrent transmission and in an opposite case of non-concurrent transmission method according to the exemplary embodiment of the present invention, respectively;

FIG. 5 is a graph showing expected throughputs of DCF and an exemplary embodiment of the present invention;

FIG. 6 shows a WLAN system to which the opportunistic concurrent transmission method according to another exemplary embodiment of the present invention is applied;

FIG. 7 shows a packet transmission process when a conventional packet queue is used;

FIG. 8 shows a packet transmission process when per-station queues are used according to an exemplary embodiment of the present invention;

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

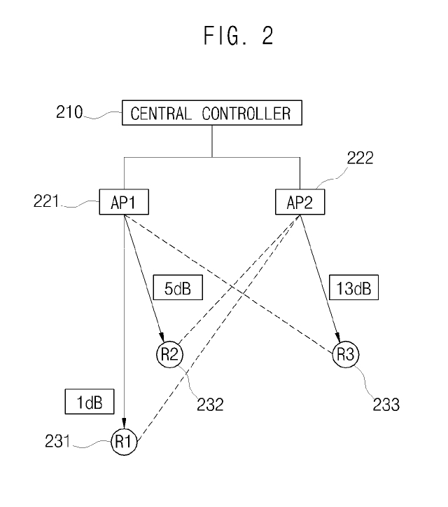

FIG. 2 is a diagram showing a WLAN system to which an opportunistic concurrent transmission method is applied according to an exemplary embodiment of the present invention.

As shown in FIG. 2, the WLAN system according to the exemplary embodiment of the present invention includes a central controller 210, two access points (APs) AP1; 221 and AP2; 222, and client devices R1; 231, R2; 232, and R3; 233 connected to each AP, respectively. Both APs are located within the transmission range of each other. Though two APs and three client devices are shown in FIG. 2 for better comprehension and ease of description, the numbers of APs and the client devices are not necessarily limited thereto.

In the figure, solid arrows mean a transmission link between an AP and a client device, and dashed lines denote interferences among concurrent transmissions. The value in a box indicates received SINR when packets are transmitted concurrently. That is, the clients R1 and R2 are associated with AP1 and a signal transmitted from AP2 becomes an interference signal for R1 and R2. On the contrary, the client R3 is associated with AP2 and, as a result, a signal transmitted from AP1 becomes the interference signal for R3. When concurrent transmission is made from AP1 and AP2, R1, R2, and R3 receive signals having SINRs of 1 dB, 5 dB, and 13 dB, respectively.

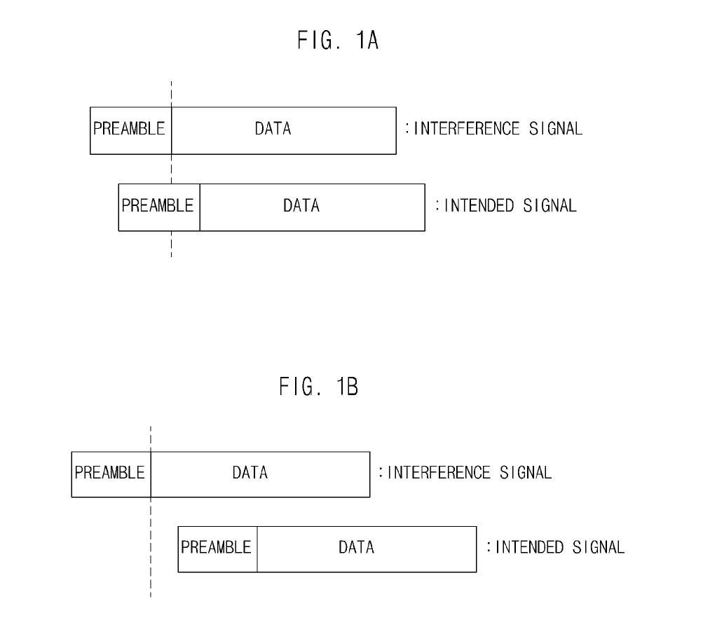

AP1 and AP2 may transmit concurrently by referring to an interference map. The interference map is a table of relative signal strength of each transmission depending on the transmission orders. In the exemplary embodiment shown in FIG. 1, the central controller 210 makes interference map from the individual report of each AP and distributes it to all APs. However, there are lots of schemes that make an interference map without a central controller.

Hereinafter, an opportunistic concurrent transmission method according to the exemplary embodiment of the present invention will be described referring to FIG. 2. It is assumed that each of AP1 and AP2 has packets to transmit to its associated clients R1 and R3, respectively.

Let AP1 transmit a packet to R1 first, and AP2 transmit a packet to R3 after the preamble time of the AP1's packet. AP1's transmission may result in a collision and cannot be decoded successfully by R1 since the SINR value (1 dB) of the received signal does not satisfy the capture threshold (4 dB). Of course, AP2's transmission may succeed due to a higher SINR value of 13 dB.

Now, let us change the transmission link. If AP1 transmits a packet to R2 not to R1, then a following concurrent transmission of AP2 may not corrupt the AP1's packet. The reason is that SINR value of R2 (5 dB) is higher than the capture threshold (4 dB).

Consequently, AP2 has an opportunity to transmit a packet concurrently with AP1 when AP1 send a packet to R2. AP2 can overhear the transmission of AP1 and knows which link is used in this transmission by sniffing the MAC header of the ongoing packet. Referring the interference map, AP2 knows that its concurrent transmission will not destroy the ongoing transmission of AP1. That is, AP2 assures its concurrent transmission satisfy the required SINR thresholds for capturing both packets.

When it is determined that the concurrent transmission will cause a problem, that is, when it is determined that the transmission of another AP will fail by the concurrent transmission, the AP defers its own transmission as a standard DCF operation.

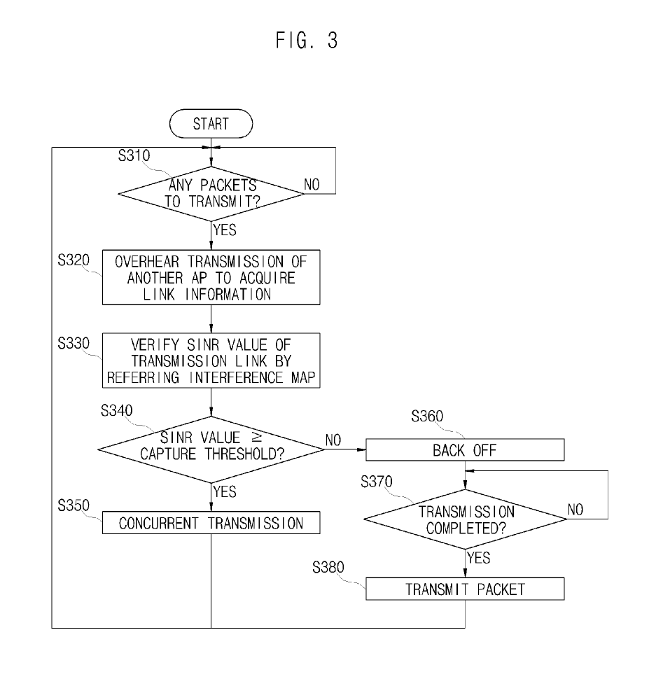

FIG. 3 is a flowchart showing an opportunistic concurrent transmission method from a viewpoint of one AP according to an exemplary embodiment of the present invention.

First, an AP determines whether there are packets to be transmitted (S310). If so, the AP overhears transmission from another AP to acquire information on a transmission link (S320). Next, AP finds out the SINR value for the transmission link by referring to the interference map (S330). If the SINR value is equal to or higher than the capture threshold (S340), the AP transmits its packets concurrently (S350). If the SINR value is lower than the capture threshold (S340), the AP enters the back off period (S360) and waits for the transmission to be completed. When the transmission in completed (S370), the AP transmits its own packets (S380).

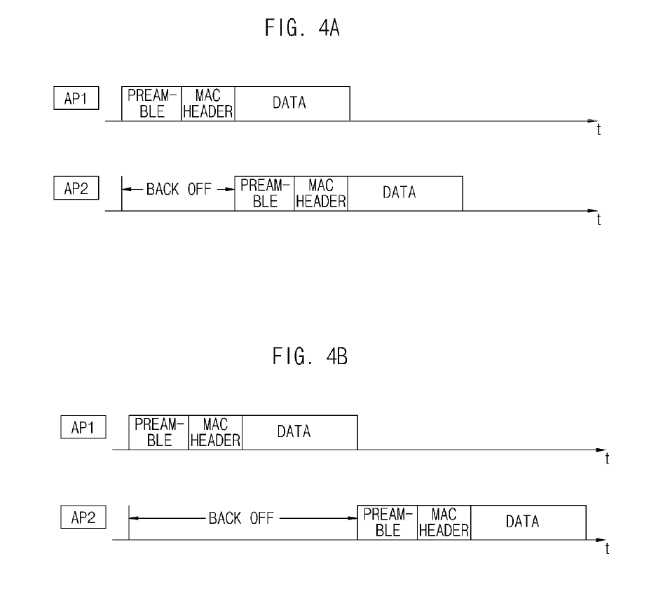

FIGS. 4A and 4B shows timings of the opportunistic concurrent transmission and non-concurrent transmission, respectively.

FIG. 4A shows the case of concurrent transmission. While AP1 is transmitting a frame, AP2 determines whether concurrent transmission can be made through a MAC header of the frame being transmitted by AP1 and the interference map. If AP2 determines to transmit concurrently, AP2 transmits its own frame right away.

On the contrary, FIG. 4B shows the case in which it is determined that concurrent transmission is not made. When AP2 overhears the transmission of AP1 and determines that concurrent transmission is not made, AP2 waits until the transmission of AP1 is completed and transmits its own frame later.

Meanwhile, the opportunistic concurrent transmission method according to the exemplary embodiment of the present invention operates well in broadcast scenario, because broadcasts do not use ACK packets. However, the opportunistic concurrent transmission method requires a more sophisticated ACK processing mechanism in unicast scenario. Here is one possible solution. We can avoid ACK collisions by scheduling ACK packets to be serialized by referring to the MAC header. That is, since a transmission time of the ACK frame can be found by referring a MAC header of a packet which another AP is transmitting, its own frame schedule may be planned not to be overlapped with the ACK frame of the packet which another AP is transmitting. For example, AP2 knows an ACK transmission time of AP1 by the MAC header information of AP1's packet in FIG. 4A.

A simulation is performed in order to compare the performances of the opportunistic concurrent transmission method according to the exemplary embodiment of the present invention and DCF. The expected throughput means the number of transmitted data bits divided by the total transmission time. We compare the expected through put of both DCF and the opportunistic concurrent transmission method according to the exemplary embodiment of the present invention with the broadcast operation. To simplify the analysis, we assumed that there is no collision. Therefore, the expected throughput of DCF is expressed as follows.

$$ET\_DCF = \frac{data size}{DIFS + BackOff + TXdur}$$

$$where$$

$$TXdur = \frac{data size + MAXheader + preamble}{TXrate}$$

In the opportunistic concurrent transmission method according to the exemplary embodiment of the present invention, it requires additional one preamble time plus one MAC header time to send two packets simultaneously. Thus, we obtain the expected throughput of the opportunistic concurrent transmission method according to the exemplary embodiment of the present invention as followings. Herein, OMCT is an abbreviation of Opportunistic MIM-aware Concurrent Transmission which represents the opportunistic concurrent transmission according to the exemplary embodiment of the present invention.

$$ET\_OMCT = \frac{2 * data size}{DIFS + BackOff + TXdur}$$

$$where$$

$$TXdur = \frac{data size + 2 ( MAC header + preamble )}{TXrate}$$

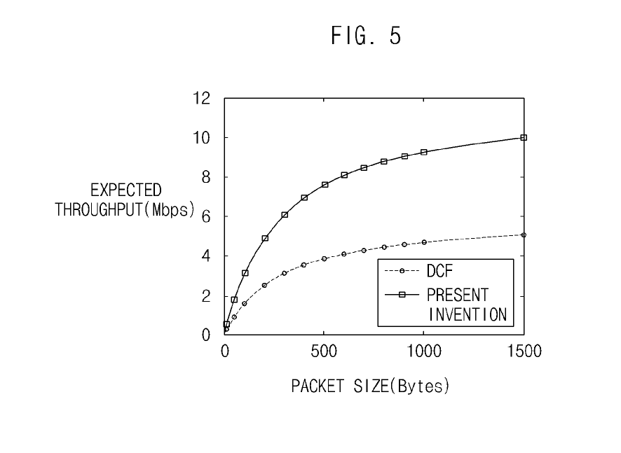

We insert the typical values of IEEE 802.11b parameters in equations above and get the results. FIG. 5 shows the expected throughput of both DCF and the exemplary embodiment of the present invention as a function of data size. We set the data rate 11 Mbps and vary the data size from 10 bytes to 1500 bytes. The result shows that the exemplary embodiment of the present invention outperforms DCF up to 200% in terms of the expected throughput.

In the exemplary embodiment described above, the opportunistic concurrent transmission method is used in a WLAN system, but the method is not limited thereto and may be applied to another wireless network system such as a wireless ad hoc network, or the like.

It is preferable that the opportunistic concurrent transmission method according to the exemplary embodiment of the present invention is applied only to a downlink transmission, the transmission from an AP to a client device, while an uplink transmission, the transmission from the client device to the AP, is made as a standard DCF operation. Despite of that, transmission efficiency can be remarkably improved. The reason is that in a general WLAN system, most transmissions are made as the downlink.

Hereinafter, a queue operation technique for maximizing transmission opportunities in the opportunistic concurrent transmission method according to the exemplary embodiment of the present invention will be described.

It is important to increase concurrent transmission opportunities as many as possible in order to maximize throughput. Sometimes, an AP may lose the concurrent transmission opportunity due to a sequence of packets stored in a packet queue. Such an example will be described with reference to the figures below.

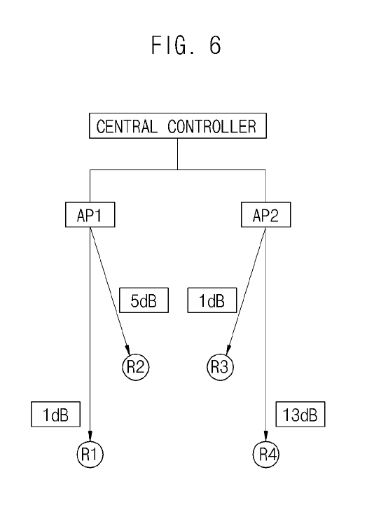

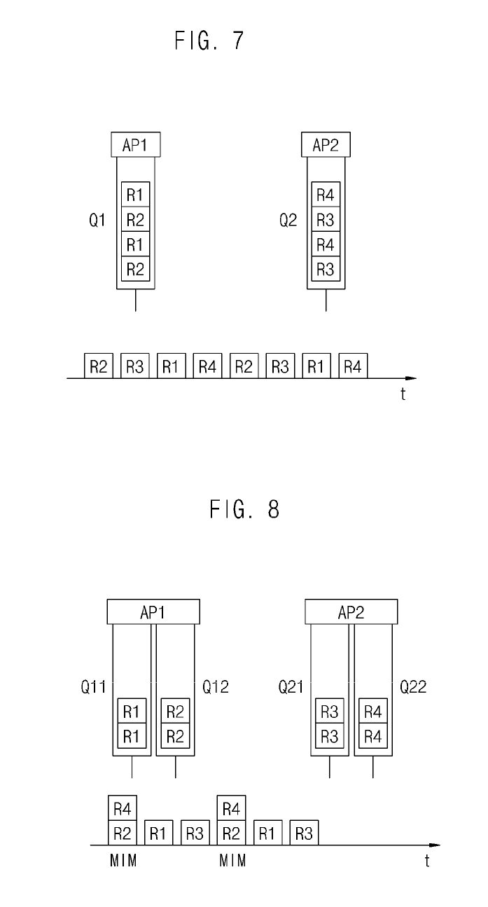

FIG. 6 shows another example of the WLAN system to which the opportunistic concurrent transmission method according to the exemplary embodiment is applied. FIG. 7 shows a packet transmission process using a conventional packet queue, and FIG. 8 shows a packet transmission process using per-station queues according to an exemplary embodiment of the present invention.

In the WLAN system shown in FIG. 6, when AP1 transmits the packet to R2 (AP1→R2), AP2 has an opportunity to concurrently transmit the packet to R4 (AP2→R4) by utilizing the MIM function. However, it depends on the packet arrangement in the queues of AP1 and AP2 whether concurrent transmission can be made.

In a conventional WLAN system, as shown in FIG. 7, each AP has one packet queue. AP1 stores the packets to be transmitted to the client devices R1 and R2 associated therewith in a packet queue Q1, and AP2 stores the packets to be transmitted to the client devices R3 and R4 associated therewith in a packet queue Q2, respectively. When two or more client devices are associated with one AP, packets are arranged in the queue in order of arrival.

When AP2 attempts a transmission to R4 while AP1 is transmitting packets to R2, AP2 has the concurrent transmission opportunity. If packets are arranged in the packet queue Q2 of AP2 as shown in the upper portion of FIG. 7, it is not R4 to be transmitted next but R3, which is placed in a packet queue header of AP2. Thus, concurrent transmission is unavailable, and packets are individually transmitted in order of R2, R3, R1, and R4 as shown in the lower portion of FIG. 7.

To solve this problem, per-station queues are allocated to a plurality of clients devices associated with each AP according to the exemplary embodiment of the present invention

As shown in FIGS. 8, AP 1 and AP2 have per-station queues Q11 and Q12; Q21 and Q22 for two client devices R1 and R2; R3 and R4 associated therewith, respectively and store packets to be transmitted to the client devices in the per-station queues.

According to the exemplary embodiment of the present invention having queues shown in the upper portion of FIG. 8, the packets are transmitted in sequence from the individual queues Q11 and Q12; Q21 and Q22. Therefore, as shown in the lower portion of FIG. 8, concurrent transmission to R2 and R4 becomes available. That is, the transmission order may be repeated on a cycle of R2:R4 (concurrent transmission)→R1→R3.

If there are two packets to be transmitted to each client device, total of 6 transmission periods completes transmission, while it needs 8 transmission periods for a system having queue arrangement shown in FIG. 7.

When concurrent transmission is not made, the packets are extracted and transmitted in sequence from the per-station queues Q11 and Q12; Q21 and Q22.

Though two APs and two client devices for each AP are shown in FIGS. 6 to 8 for better comprehension and ease of description, the numbers of APs and the client devices associated with each AP are not necessarily limited thereto. If there are more than two client devices associated with an AP, the AP may be furnished with per-station queues as many as associated client devices by allocating one per-station queue to each client device.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for transmitting a packet of an access point provided in a wireless network system, comprising:
acquiring information on a link which is performing transmission from another access point by overhearing the transmission from another access point when there is a packet to be transmitted;
verifying a signal to interference plus noise ratio (SINR) value of the link by referring an interference map; and
concurrently transmitting the packet when the verified SINR value is equal to or more than a predetermined capture threshold.

2. The method of claim 1, wherein:
the wireless network system includes a central controller, and
the interference map is provided by the central controller.

3. The method of claim 1, further comprising: entering a back off state when the verified SINR value does not reach the predetermined capture threshold.

4. The method of claim 3, further comprising: after the entering a back off state, transmitting the packet when the transmission from another access point is completed.

5. The method of claim 1, wherein:
the access point maintains two or more per-station queue storing packets to be transmitted to two or more client devices associated with the access point; and
concurrently transmitting comprises scheduling to concurrently transmit a packet available for concurrent transmission among the packets stored in the per-station queues.

6. The method of claim 5, wherein the packet available for concurrent transmission is a packet having SINR value equal to or more than the predetermined capture threshold.

7. A wireless network system including two or more access points, wherein:
when any one of the access points intends to transmit a packet, information on a link which is performing transmission is acquired from another access point by overhearing the transmission from another access point,
a signal to interference plus noise ratio (SINR) value of the link is verified by referring to an interference map, and
when the verified SINR value is equal to or more than a predetermined capture threshold, the packet is concurrently transmitted.

8. The system of claim 7, further comprising: a central controller connected to two or more access points,
wherein the central controller generates the interference map and provides the generated interference map to the access points.

9. The system of claim 7, wherein the access point which intends to transmit a packet enters a back off state when the verified SINR value does not reach a predetermined capture threshold.

10. The system of claim 7, wherein the access point which intends to transmit a packet transmits the packet when the transmission from another access point is completed.

11. The system of claim 7, wherein:
the access point maintains two or more per-station queues storing packets to be transmitted to two or more client devices associated with the access point; and
the access point schedules to concurrently transmit a packet available for concurrent transmission among the packets stored in the per-station queues.

12. The system of claim 11, wherein the packet available for concurrent transmission is a packet having SINR value equal to or more than the predetermined capture threshold.

13. An access point in a wireless network system, the access point is characterized in that:
information on a link which is performing transmission from another access point is acquired by overhearing transmission from another access point when a packet to be transmitted is provided,
a signal to interference plus noise ratio (SINR) value of the link is verified by referring an interference map, and
the packet is concurrently transmitted when the verified SINR value is equal to or more than a predetermined capture threshold.

14. The access point of claim 13, wherein:
the wireless network system further includes a central controller, and
the access point receives the interference map from the central controller.

15. The access point of claim 13, wherein the access point enters a back off sate when the verified SINR value does not reach a predetermined capture threshold.

16. The access point of claim 13, wherein the access point transmits the packet when the transmission from another access point is completed.

17. The access point of claim 13, wherein:
the access point maintains two or more per-station queues storing packets to be transmitted to two or more client devices associated with the access point; and
the access point schedules to concurrently transmit a packet available for concurrent transmission among the packets stored in the per-station queues.

18. The system of claim 17, wherein the packet available for concurrent transmission is a packet having SINR value equal to or more than the predetermined capture threshold.
